(19) United States
(12) Patent Application Publication
(10) Pub. No.: US 2013/0179975 A1
(43) Pub. Date: Jul. 11, 2013

(54) Method for Extracting Digital Fingerprints of a Malicious Document File

(71) Applicants: Ming-Chang Chiu, Taipei City (TW); Ming-Wei Wu, Taipei City (TW); Ching-Chung Wang, Taipei City (TW); Che-Kuo Hsu, Taipei City (TW); Pei-Kan Tsung, Taipei City (TW)

(72) Inventors: Ming-Chang Chiu, Taipei City (TW); Ming-Wei Wu, Taipei City (TW); Ching-Chung Wang, Taipei City (TW); Che-Kuo Hsu, Taipei City (TW); Pei-Kan Tsung, Taipei City (TW)

(73) Assignee: Xecure Lab Co., Ltd.

(21) Appl. No.: 13/612,802

(22) Filed: Sep. 12, 2012

(30) Foreign Application Priority Data
Jan. 10, 2012 (TW) 101100907

(51) Int. Cl. G06F 21/00

(52) U.S. Cl. 726/24

(57) ABSTRACT

A method for extracting the genetic fingerprinting of a malicious document file includes the steps of establishing a database to store a plurality of genetic fingerprinting data of the first malicious document, then retrieving a document file sent via the Internet, and then proceeding with multi-point detection and extraction to the document file, so as to obtain a multi-point section, then comparing and analyzing the multi-point section with the plurality of genetic fingerprinting data of the first malicious document to confirm whether the multi-point section program code of the document file matches a malicious feature, thereby achieves the goal of extracting the content information of the document file and converts it into the genetic fingerprinting data of a new malicious document.

### BACKGROUND OF THE INVENTION

1. Field of the Invention

This invention is related to a method for extracting genetic fingerprinting of a malicious document file, and more particularly to a method for retrieving the content information of a document file sent via the Internet, and comparing the content information with a malicious feature previously stored in a database and transforming the content information into a genetic fingerprinting data if the content information fits the profile of the malicious feature.

2. Description of Related Art

Conventional antivirus software is unable to detect the attack of malicious document files and protect the designated/undesignated file. In order to examine whether the document files (such as: doc file, xls file, ppt file, pdf file etc.) contain malicious code, current antivirus softwares compare the program code(s) of specific section(s) of the document files with know malicious codes. If the comparison result indicates that the program code of specific section matches with the characteristics of the virus, the antivirus software will enable the protection mechanism to isolate the infected document file, or remove the virus from the infected document file.

However, the document file with malicious attack file is different from the document file with virus. The document file with malicious attack file contains malicious program code embedded in multi-sections of a program file during compiling. The malicious program code embedded in multi-sections of a program file cannot be detected via anti-virus software as the anti-virus software only targets a certain section of the document file. As of the different characteristics between these two document files, the document file with malicious attack will easily pass the detection of the anti-virus software and disable user's computer.

Therefore, how to develop a new detection method targeting document file with malicious attack is the issue the industry needs to resolve in urgent.

### SUMMARY OF THE INVENTION

The objective of the present invention is to provide a method for extracting genetic fingerprinting of a malicious document file.

First of all, the first step of the preferred embodiment of the present invention is establishing a database to store a plurality of genetic fingerprinting data of a first malicious document file. And then the second step is retrieving a document file sent via the Internet. The next step is proceeding with multi-point detection and extraction to the document file, so as to obtain a multi-point section. Finally the last step is comparing and analyzing the multi-point section with the genetic fingerprinting data of the first malicious document file to confirm whether the multi-point section of the document file matches with any of the docketed genetic fingerprinting data of the first malicious document file, thereby achieving the goal of extracting the information about the document file.

In order to achieve the above-mentioned objective, the method of the preferred embodiment of the present invention includes the following steps: the first step is establishing a database to store a plurality of genetic fingerprinting data of a first malicious document; and then the second step is retrieving a document file sent via the Internet; the next step is proceeding with multi-point detection and extraction to the document file, so as to obtain a multi-point section; finally the last step is comparing and analyzing the multi-point section with the plurality of genetic fingerprinting data of the first malicious document to confirm whether the multi-point section of the document file matches with any of the docketed genetic fingerprinting data of the first malicious document file.

### BRIEF DESCRIPTION OF THE DRAWINGS

The invention, as well as its many advantages, may be further understood by the following detailed description and drawings in which:

FIG. 1 is a flow chart showing the steps for extracting genetic fingerprinting of malicious document files of the present invention; and

FIG. 2 is an architecture block diagram showing a system of extracting genetic fingerprinting of malicious document files of the present invention.

### DETAILED DESCRIPTION OF THE INVENTION

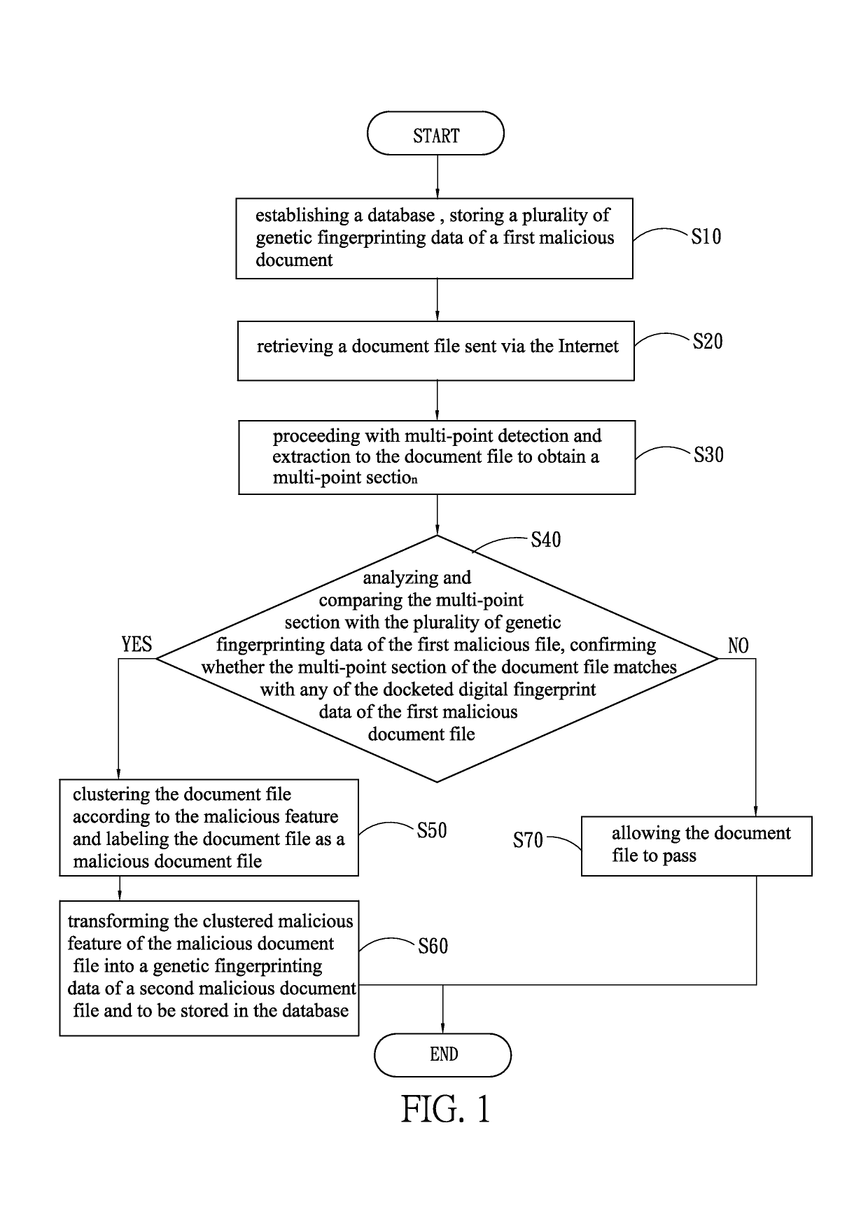

With reference to FIG. 1, a flow chart showing the method for extracting genetic fingerprinting of malicious document file of the preferred embodiment of the present invention is shown. The executing steps are as followings:

First of all, start from step S10: establishing a database 11, storing a plurality of genetic fingerprinting data of a first malicious document, then forward to step S20,

In step S20: retrieving a document file sent via the Internet 2, then forward to step S30.

In step S30: proceeding with multi-point detection and extraction to the document file to obtain a multi-point section, and then forward to step S40.

In step S40: analyzing and comparing the multi-point section with the plurality of genetic fingerprinting data of the first malicious file, confirming whether the multi-point section of the document file matches with any of the docketed genetic fingerprinting data of the first malicious document file, if “matched”, go to step S50; if “not matched”, go to step S70.

In step S50: clustering the document file according to the malicious feature and labeling the document file as a malicious document file, and then forward to step S60.

In step S60: transforming the clustered malicious feature of the malicious document file into a genetic fingerprinting data of a second malicious document file and to be stored in the database 11.

In step S70: allowing the document file to pass.

In this embodiment, the multi-point section may be selected from the group consisting of the information content, the coding address or the loopholes of the document file.

In this embodiment, the clustering is performed according to plural Internet Communication addresses (such as a relay station), plural malwares and plural loopholes of the document file.

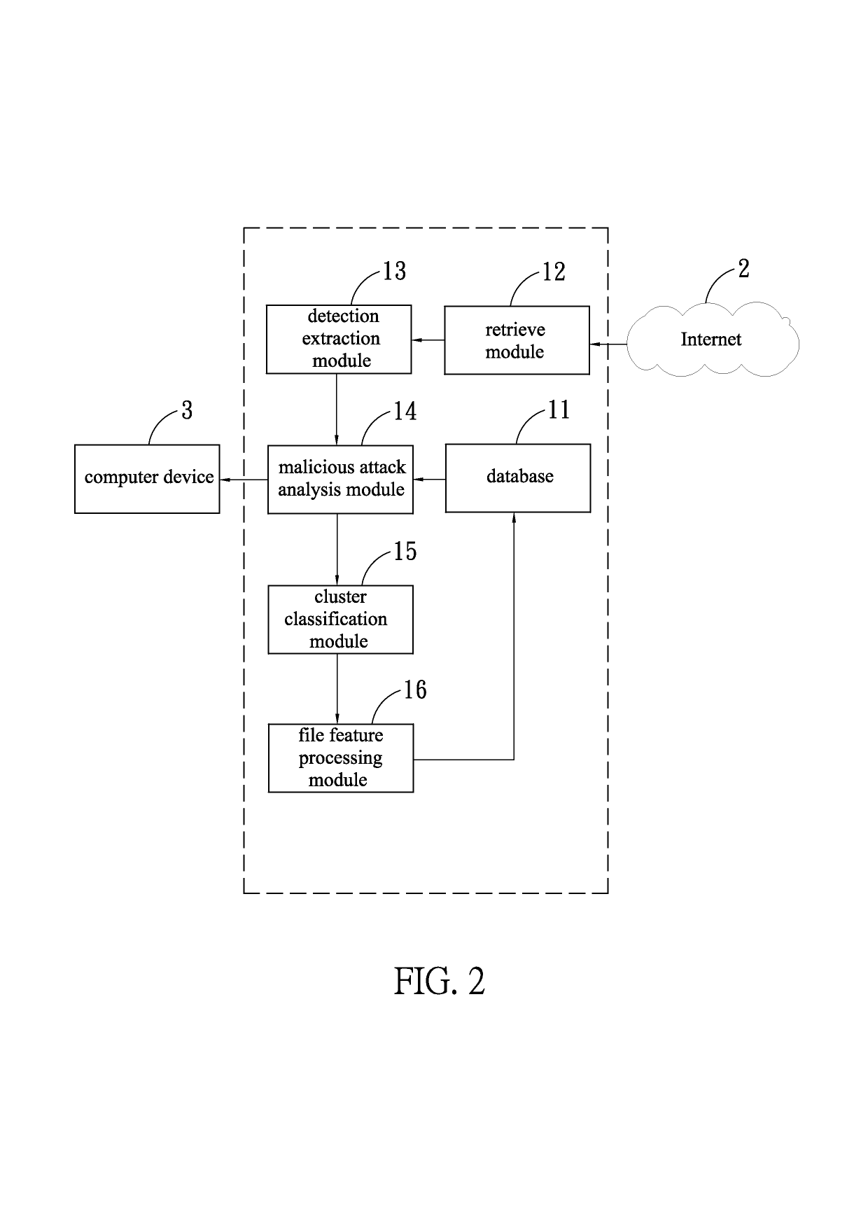

With reference to FIG. 2, an architecture block diagram showing a system of extracting genetic fingerprinting of a malicious document file of the present invention includes a database 11, a retrieve module 12, a detection extraction module 13, a malicious attack analysis module 14, a cluster classification module 15 and a file feature processing module 16.

The database 11 stores a plurality of genetic fingerprinting data of a first malicious document.

The retrieve module 12 retrieves a document file retrieved from the Internet.

The detection/extraction module 13 proceeds with multi-point detection and extraction to the document file, so as to obtain a multi-point section.

The malicious attack analysis module 14 analyzes and compares the multi-point section with the plurality of genetic fingerprinting data of the first malicious document so as to confirm whether program code of the multi-point section matches with any of the docketed genetic fingerprinting data of the first malicious document file.

The cluster classification module 15 proceeds with a clustering classification to those document files if their content information fits the profile of the malicious feature, and marks the files as malicious document files.

The file feature processing module 16 transforms the malicious feature of the classified document file into a genetic fingerprinting data of a second malicious document, and stores the data in the database 11.

When the document file is transmitted to a user's computer device 3 via the Internet 2 (such as: e-mail, instant messaging software, IP and URL), the document file will be retrieved by the retrieving module 12 and the multi-point section of the document file will be obtained by the detection and extraction of the detection/extraction module 13. Then, the multi-point section and the genetic fingerprinting data of the first malicious document in the database 11 are compared and analyzed by the malicious attack analysis module 14 to determine whether the multi-point section matches with the malicious feature of the genetic fingerprinting data of the first malicious document. If match does not exist, the document file is allowed to pass to the user's computer device 3.

If “match” is found during comparison, the document file will be classified by the cluster classification module 15 according to the Internet Communication addresses (such as a relay station), the malwares and the loopholes thereof. After the cluster classification is finished, the document file will be converted into a genetic fingerprinting data of a second malicious document by the file feature processing module 16 in accordance with the malicious feature of the classified document file and stored in the database 11.

Furthermore, the method and system for extracting genetic fingerprinting of malicious document file of the present invention are used to detect those malicious attack program hidden in the document file.

This kind of malicious exploit code uses different program encodings instead of those traditional viruses. Because the compiling or encoding of the malicious exploit code will be hidden in multiple sections of the document file, not just one particular section, which can not be easily detected and protected by any general anti-virus software, it is needed to detect the multiple sections hidden in the document file so as to determine whether the multiple sections of the document file are abnormal or having loopholes of the document file.

When the multiple sections of the document file are detected as abnormal or having loopholes, the document file with malicious exploit code will be categorized according to the Internet Communication addresses (such as a relay station), the malwares and the loopholes thereof. After the categorization is finished, the categorized document file with malicious exploit code will be converted into a genetic fingerprinting data of the second malicious document and the genetic fingerprinting data of the second malicious document will be stored in the database 11 for subsequent detection and analysis.

It is clear from the above description, the method and system for extracting genetic fingerprinting of a malicious document file of the present invention establish a database 11 first and store the plurality of genetic fingerprinting data of the first malicious document. Then a document file sent via Internet 2 is retrieved. The next step is to proceed with multi-point detection and extraction to the document file, so as to obtain the multi-point section. The multi-point section with the plurality of genetic fingerprinting data of the first malicious document is compared and analyzed to confirm whether the multi-point section of the document file matches a malicious feature, If “matched”, the malicious feature extracted from the document file will be converted into the genetic fingerprinting data of the second malicious document, thereby achieving the goal of extracting the information about the document file and storing the genetic fingerprinting data as a new malicious document.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for extracting genetic fingerprinting of a malicious document file, comprising steps of:
establishing a database to store a plurality of genetic fingerprinting data of a first malicious document file;
retrieving a document file sent via Internet;
proceeding with multi-point detection and extraction to the document file so as to obtain a multi-point section; and
comparing and analyzing the multi-point section with the plurality of genetic fingerprinting data of the first malicious document file to confirm whether the multi-point section of the document file matches with any docketed genetic fingerprinting data of the first malicious document file.

2. The method as claimed in claim 1 further comprising a step of clustering categorization in compliance with the malicious feature and to be labeled as a malicious document file when the content information of the document file fits profile of the malicious feature.

3. The method as claimed in claim 2, further comprising:
transforming the malicious feature into a genetic fingerprinting of a second malicious document file to be stored in the database.

4. The method as claimed in claim 3, wherein the clustering categorization is proceeded according to plural Internet communications addresses, plural malware, and plural vulnerabilities.

5. The method as claimed in claim 1, wherein the multi-point section is one selected from the group consisting of: content of the document file, coding address and loopholes of the document file.
